(19) United States
(12) Patent Application Publication
(10) Pub. No.: US 2015/0326549 A1
(43) Pub. Date: Nov. 12, 2015

(54) OPERATING SOFTWARE IN A VIRTUAL MACHINE ENVIRONMENT

(71) Applicant: HANGZHOU H3C TECHNOLOGIES CO., LTD., Hangzhou, Zhejiang (CN)

(72) Inventor: Yonggang ZENG, Beijing (CN)

(21) Appl. No.: 14/652,759

(22) PCT Filed: Dec. 11, 2013
(86) PCT No.: PCT/CN2013/089037

§ 371 Date: Jun. 16, 2015

(30) Foreign Application Priority Data
Dec. 28, 2012 (CN) 201210587138.7

(51) Int. Cl. H04L 29/06; G06F 21/10; G06F 9/455

(52) U.S. Cl. CPC H04L 63/08; G06F 9/45558; G06F 21/105; G06F 2009/45587

(57) ABSTRACT

A method of operating software in a virtual machine environment which is resident on a physical machine. The method comprises examining authenticity of a software license against authentication information stored in the virtual machine environment after activation of the software. The authentication information comprises unique virtual machine identification information that defines a unique association between the virtual machine and the physical machine.

### BACKGROUND

Virtual machines are typically created by virtual machine software on a physical machine. VMware® is an example of a widely used virtual machine software. Virtual machine software is also known as a ‘virtual machine monitor’.

A virtual machine monitor is an additional layer of software between the hardware of the physical machine and an operating system that virtualises the hardware resources of the physical machine. The virtual hardware execution environment created by a virtual machine monitor is known as a ‘virtual machine’(VM). A VM can be regarded as software pretending to be hardware.

Many types of software such as application software or system software (operating systems) require a license to operate. Many licensed software and include anti-piracy measures. On-line activation or on-line license authentication is a typical example of anti-pirate measures to prevent installing a copy of licensed software on many computers. However, on-line activation or authentication can be a problem when a user has no Internet access when application software (Apps) is to be run. Another example of anti-piracy measures is by installing an authentication centre within a private network (LAN). However, such an authentication centre can be cloned and installed on another LAN.

In any event, the way that clones of existing virtual machines can be easily made by a virtual machine monitor makes such anti-pirate measures less than effective.

### DESCRIPTION OF FIGURES

The disclosure will be described by way of non-limiting example with reference to the accompanying Figures, in which:

FIG. 1A is a flow diagram depicting an example method according to the present disclosure,

FIG. 1B is a flow diagram depicting another example method according to the present disclosure during first activation of software,

FIG. 2 is a flow diagram depicting subsequent activation of the software,

FIG. 3 is a flow diagram depicting an example implementation of the method according to the disclosure,

FIG. 4 is a diagram depicting a virtual machine first activating a licensed software according to an example of the present disclosure, and

FIG. 5 is a diagram depicting a virtual machine subsequent activation of a licensed software according to an example of the present disclosure.

### DESCRIPTION

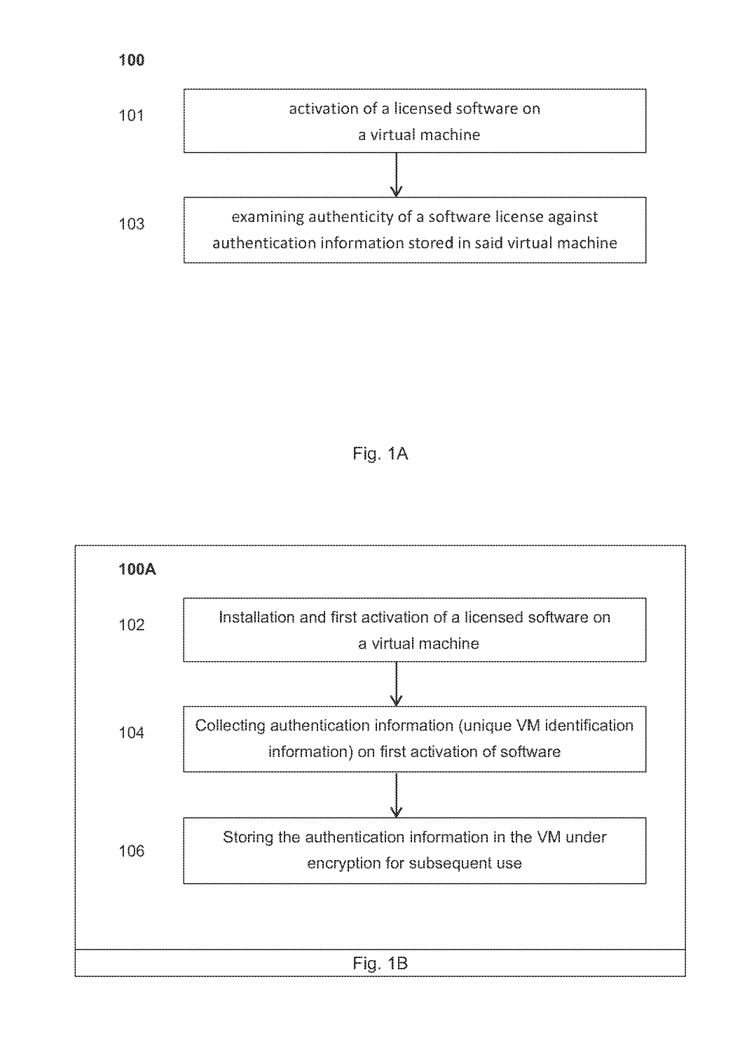

To alleviate piracy problems associated with licensed software by cloning of virtual machines, there is provided a method of operating software in a virtual machine environment in which the virtual machine environment is resident on a physical machine. The example method of FIG. 1A comprises after activation of said software at 101 and examining authenticity of a software license against authentication information stored in said virtual machine environment at 103. The authentication information comprises unique virtual machine identification information that defines a unique association between said virtual machine and said physical machine. The authentication information may optionally comprise hardware identification information of the physical machine.

As depicted in an example method 100A of FIG. 1A, upon installation and first activation of application software (Apps) on a virtual machine (VM) at block 102, authentication information will be collected at block 104, and the collected authentication information will be stored in the VM under encryption at block 106 for subsequent use.

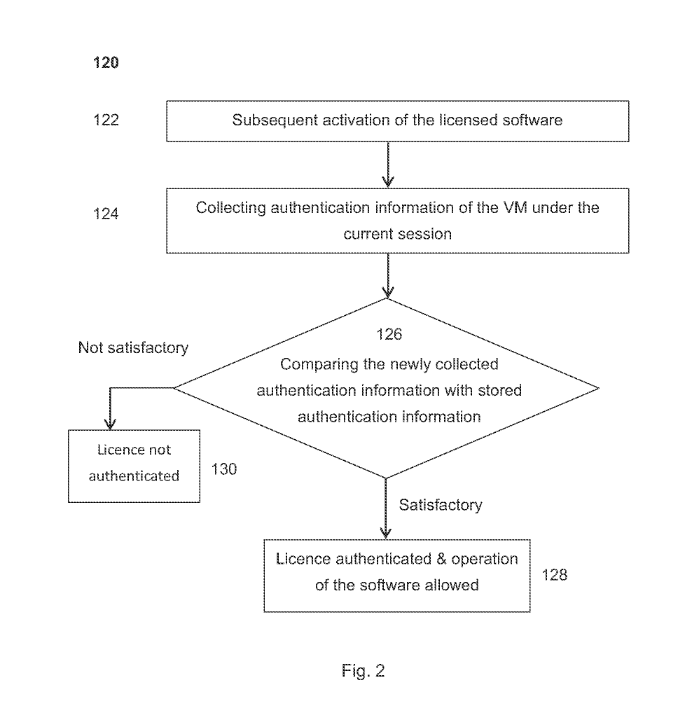

As depicted in the example method 120 of FIG. 2, when the licensed application software is subsequently activated at 122, authentication information for verifying the authenticity of the license is collected at 124. The newly collected authentication information of the VM under the current activation session will be compared with the stored authentication information at 126. If the outcome of comparison is satisfactory, this satisfactory outcome means that the VM holds an authentic license, the license is authenticated and the licensed application software will operate as depicted at block 128. If the outcome of comparison is non-satisfactory, this non-satisfactory outcome means that the VM does not hold an authentic license, license authentication is failed as depicted at block 130.

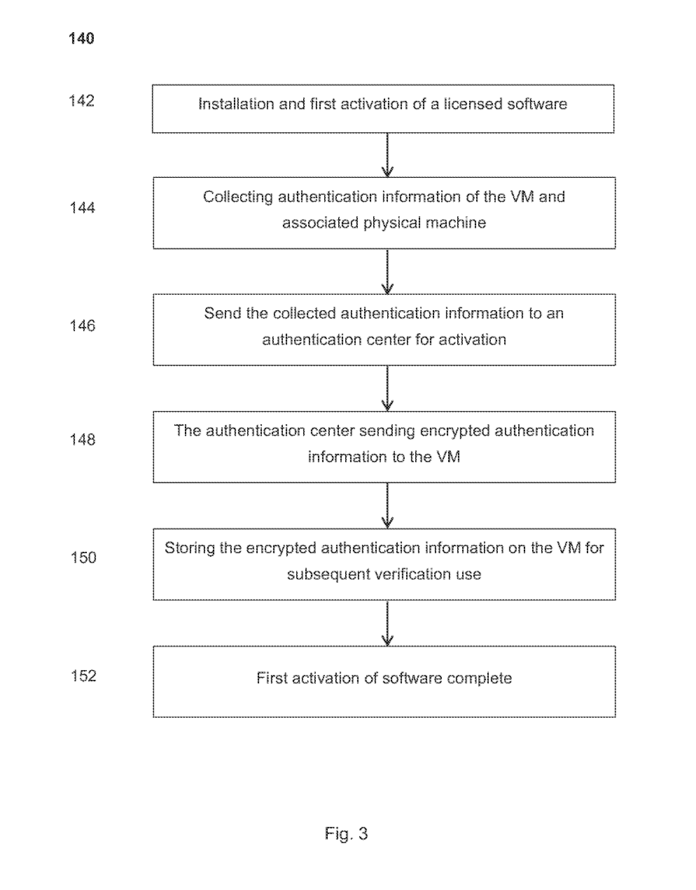

In an example implementation of the license authentication scheme 140 as depicted in FIG. 3, when a software that requires a license to operate is activated for the first time as depicted in block 142, a processor of the execution machine that executes the software will determine whether the environment running the software is virtual or physical. If the environment is a physical environment, conventional license authentication measures can be used. If the environment is a virtual environment signifying a virtual machine, the executing machine will proceed to collect unique hardware identification information of the physical machine on which the virtual machine is resident as depicted in block 144. For instance, the CPU serial number or ID, serial number of the hard disk on which the software is resident, MAC address of the network card, are examples of unique hardware identification information of a physical machine that can be used for this purpose.

After the unique hardware identification information has been collected, unique VM identification information on the physical machine such as the vendor identification of the virtual machine monitor and the physical machine hardware access parameters are collected. VMWare® ESX/ESXi, Microsoft® Hyper-v, Citrix® XenServer are examples of some known virtual machine vendors and virtual machine monitors. Where VMWare® ESX/ESXi is used as an example virtual machine monitor, SOAP parameters can be used as access parameters. Of course, other parameters that are characteristic a VM monitor and its associated physical machine can be used as access parameters. Unique hardware identification information and unique VM identification information are collectively referred to as authentication information herein.

[0010]The collected authentication information may then be encrypted and is stored on the virtual machine. The vendor identification and access parameters are provided by a user upon request of the software in an example. After the access parameters have been provided by a user, the execution machine will operate to verify whether the virtual machine is indeed resident on that physical machine. The verification can be performed by reading hardware identification information directly from the executing machine. If the verification failed, software activation will be terminated.

If the verification is successful, unique VM identification information that is characteristic of the virtual machine when operating on a specific physical machine will be collected. Vendors can have different forms of unique VM identification information. For example, objectID is a unique VM identification information for VMWare® ESX/ESXi. In general, UUID (Universal Unique Identifier), objectID, key, etc are example of unique VM identification information that can be used. UUID is a universal code that serves to provide a unique identity to a network device that is Internet accessible. This unique VM identification information and the collected hardware information are encrypted and used to facilitate completion of software activation. As depicted in block 146, the collected authentication information will be sent to an authentication centre for registration and authentication information will be sent back to the VM under encryption as depicted in block 148. The encrypted authentication information will be stored in the VM for subsequent verification use as depicted in block 150 and first activation of the licensed software is completed at block 150.

Therefore, after the collected unique VM identification information and hardware information have been used to activate the software, the encrypted VM identification information and hardware information will be stored for subsequent use. In this example, the unique VM identification information and hardware information are sent to an authentication centre to activate the software, and the authentication centre will send back keys containing encrypted the collected unique VM identification information and hardware information to the virtual machine for subsequent authentication use. In another example, the encryption of authentication information can be performed by the software within the VM environment and stored for subsequent use.

On subsequent use of the software, the execution machine will extract unique VM identification information and hardware information from the instantaneous operating environment and makes a comparison with the corresponding information which is stored on the virtual machine as depicted in the scheme of FIG. 2. If the hardware information and unique VM identification information are identical to that stored in the virtual machine, authentication is successful. If any change in the hardware information or unique VM identification information is found, verification is failed. If outcome of the comparison is successful, the subsequent activation is successful. Otherwise, the subsequent activation is failed.

For example, when there is a cloning of a VM, the hardware information will also be cloned, but the unique VM identification information cannot be cloned and will be dependent on a specific relationship between the VM and the physical machine. Therefore, this scheme provides an effective licensing authentication scheme for operation in virtual environment.

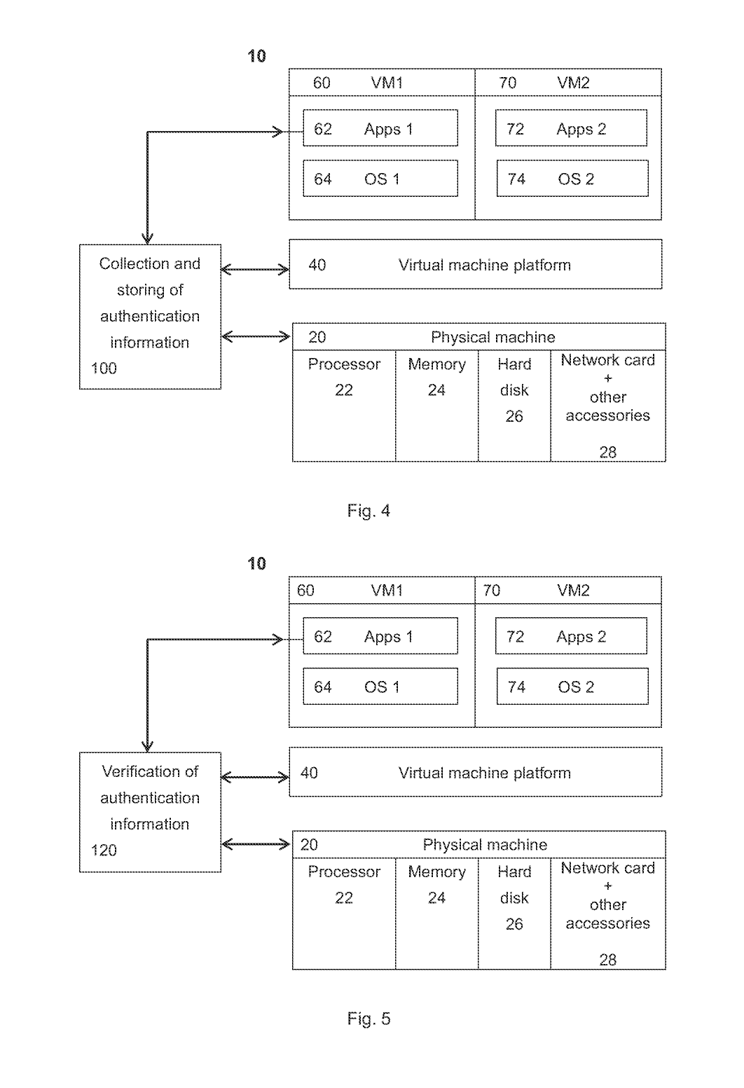

In an example apparatus depicted in FIG. 4, the apparatus 10 comprises a physical machine 20. The physical machine comprises a processor 22 and memory 24. A virtual machine monitor is operatively resident on the physical machine to create a virtual machine environment such as a virtual machine platform 40. A first virtual machine 60 is to execute a first software (Apps 1) 62 on a first operating system (OS1) 64 on the virtual machine environment 40. A second virtual machine 70 is to execute a second software (Apps 1) 72 on a second operating system (OS2) 74 on the virtual machine environment 136.

Assuming for the sake of convenience that the first application software 62 is application software having anti-piracy measures, the processor will perform a license activation process 100 as depicted in FIG. 4. On subsequent activation of the first application software 62, the processor will perform a software activation process 120 as depicted in FIG. 5 to verify authenticity of the license.

While the present disclosure has been described with reference to the above examples, it should be appreciated that the examples are for illustration only and shall not be used to restrict scope of the disclosure. For example, while various standards and protocols have been used herein for convenience, it should be understood that the present disclosure is not limited to such standards and/or protocols. Furthermore, where an apparatus comprising a processor is described, it should be appreciated that the processor can be a single processor, multiple processors, a cluster of processors, or distributed processors without loss of generality. Where a method or process is described herein, it should be appreciated that the method or process can be implemented by means of hardware, software, firmware or a combination thereof without loss of generality.

1. A method of operating software in a virtual machine environment, the virtual machine environment being resident on a physical machine, wherein the method comprises after activation of a software, examining authenticity of a software license for said software against authentication information stored in said virtual machine environment, the authentication information comprising unique virtual machine identification information that defines a unique association between said virtual machine environment and said physical machine.

2. A method according to claim 1, wherein the method comprises acquiring said authentication information and storing said authentication information in a memory of said virtual machine upon installation or first activation of said software in said virtual machine environment.

3. A method according to claim 2, wherein the method includes encrypting said authentication information and storing said authentication information in encrypted form in said virtual machine environment.

4. A method according to claim 1, wherein the method includes making subsequent use of said authentication information to determine whether a virtual machine on which the software is to operate is resident on the same physical machine as a physical machine for which the software license was first activated.

5. A method according to claim 1, wherein said unique virtual machine identification information comprises one or more of the following:
universal unique identifier (UUID). objectID, or key of said virtual machine.

6. A method according to claim 1, wherein the method includes collecting and storing hardware identification information of said physical machine in a memory of said virtual machine environment after installation or first activation of said software in said virtual machine environment, and wherein the authentication information comprises hardware identification information of said physical machine.

7. A method according to claim 1, wherein the method includes examining authenticity of said software license against authentication information acquired during a current session on operation of said software after first activation.

8. A non-transitory computer readable medium storing instructions executable by a processor to operate a software in a virtual machine environment resident on a physical machine, wherein the processor is to examine authenticity of a software license against authentication information stored in said virtual machine environment upon activation of said software, the authentication information comprising unique virtual machine identification information that defines a unique association between said virtual machine environment and said physical machine.

9. A non-transitory computer readable medium according to claim 8, wherein the processor is to make subsequent use of said authentication information to determine whether the virtual machine on which the software is to operate is resident on the same physical machine as that for which the software license was first activated.

10. A non-transitory computer readable medium according to claim 8, wherein the processor is to acquire said authentication information and store same in memory of said virtual machine upon installation and first activation of said software in said virtual machine environment.

11. A non-transitory computer readable medium according to claim 8, wherein processor is to store said acquired authentication information in said virtual machine environment under encryption.

12. A non-transitory computer readable medium according to claim 8, wherein said unique virtual machine identification information comprises one or more of the following: universal unique identifier (UUID). objectID, or key of said virtual machine.

13. A non-transitory computer readable medium according to claim 8, wherein the processor is to collect and store hardware identification information of said physical machine in said memory on installation of said software in said virtual machine environment, and the authentication information comprising hardware identification information of said physical machine.

14. A non-transitory computer readable medium according to claim 8, wherein said apparatus is a network apparatus and said hardware information of said physical machine includes one or more of the following: processor identification number (CPU ID), hard disk serial number,

[symbol]

15. A non-transitory computer readable medium according to claim 8, wherein the processor is to examine authenticity of said software license against said authentication information during operation of said software.
